(19) United States
(12) Patent Application Publication
(10) Pub. No.: US 2006/0156079 A1
(43) Pub. Date: Jul. 13, 2006

(54) Shift register system, driving method, and driving circuit for a liquid crystal display

(75) Inventors: Sz Hsiao Chen, Miao-Li (TW); Long Kuan Chen, Miao-Li (TW); Tsau Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/311,845

(22) Filed: Dec. 19, 2005

(30) Foreign Application Priority Data
Dec. 17, 2004 (TW) 93139387

(51) Int. Cl. G06K 5/04

(52) U.S. Cl. 714/699

(57) ABSTRACT

An exemplary shift register system (31) includes a counter (316), a shift register (311) and a plurality of switches (312, 313, 314, 315). The counter includes a signal receiving pin which is for connection to a first external circuit, a pulse output pin, and a number of signal output pins. The shift register includes sixty-four register units therein, sixty-four output pins, a start pin connected to the pulse output pin of the counter, a controlling pin connected to the signal receiving pin of the counter. Each switch includes sixty-four input pins connected to the output pins of the shift register through a bus line, sixty-four output pins that are for connection to a second external circuit, and an enabling pin connected to a respective one of the signal output pins of the counter. A related method for driving a shift register system, and a circuit for driving a liquid crystal display, are also provided.

### FIELD OF THE INVENTION

The present invention relates to shift register systems, and more particularly to a shift register system typically used in a liquid crystal display (LCD).

### BACKGROUND

An LCD device has the advantages of portability, low power consumption, and low radiation, and has been widely used in various portable information products such as notebooks, personal digital assistants (PDAs), video cameras and the like. Furthermore, the LCD device is considered by many to have the potential to completely replace CRT (cathode ray tube) monitors and televisions.

FIG. 4 is essentially an abbreviated circuit diagram of a conventional active matrix LCD. The active matrix LCD 100 includes a first substrate (not shown), a second substrate (not shown) arranged in a position facing the first substrate, a liquid crystal layer (not shown) sandwiched between the first substrate and the second substrate, a data driving circuit 200, a gate driving circuit 300, and a timing control circuit 400.

The first substrate includes a number n (where n is a natural number) of gate lines 101 that are parallel to each other and that each extend along a first direction, and a number m (where m is also a natural number) of data lines 102 that are parallel to each other and that each extend along a second direction orthogonal to the first direction. The first substrate also includes a plurality of thin film transistors (TFTs) 106 that function as switching elements. The first substrate further includes a plurality of pixel electrodes 103 formed on a surface thereof facing the second substrate. Each TFT 106 is provided in the vicinity of a respective point of intersection of the gate lines 101 and the data lines 102.

Each TFT 106 includes a gate electrode, a source electrode, and a drain electrode. The gate electrode of each TFT 106 is connected to the corresponding gate line 101. The source electrode of each TFT 106 is connected to the corresponding data line 102. The drain electrode of each TFT 106 is connected to a corresponding pixel electrode 103.

The second substrate includes a plurality of common electrodes 105 opposite to the pixel electrodes 103. In particular, the common electrodes 105 are formed on a surface of the second substrate facing the first substrate, and are made from a transparent material such as ITO (Indium-Tin Oxide) or the like. A pixel electrode 103, a common electrode 105 facing the pixel electrode 103, and liquid crystal molecules of the liquid crystal layer sandwiched between the two electrodes 103, 105 cooperatively define a single pixel unit.

The gate driving circuit 300 includes a first shift register 310 for receiving scanning signals, a level shift 320 for transforming the scanning signals to a plurality of voltages, and a first output circuit 330 connected to the plurality of gate lines 101.

The data driving circuit 200 includes a second shift register 210 for receiving image signals, a sampler 220 for transforming the image signals to a plurality of voltages, and a second output circuit 230 connected to the plurality of data lines 102. The first and second shift registers 310, 210 used in the gate driving circuit 300 and the data driving circuit 200 are integrated circuits (ICs).

Because the first shift register 310 has a plurality of output pins for driving the plurality of gate lines 101, the first shift register 310 must have a same number of register units therewithin. In other words, the number of output pins of the shift register 310 must be the same as the number of register units inside the shift register 310. This means that different first shift registers 310 need to be manufactured for different kinds of active matrix LCDs 100 that have different numbers of gate lines 101. This reduces a manufacturer's flexibility and may in effect add to costs.

It is desired to provide a shift register system which overcomes the above-described deficiencies.

### SUMMARY

An exemplary shift register system includes a counter, a shift register and a plurality of switches. The counter includes a signal receiving pin which is for connection to a first external circuit, a pulse output pin, and a number of signal output pins. The shift register includes sixty-four register units therein, sixty-four output pins, a start pin connected to the pulse output pin of the counter, a controlling pin connected to the signal receiving pin of the counter. Each switch includes sixty-four input pins connected to the output pins of the shift register through a bus line, sixty-four output pins that are for connection to a second external circuit, and an enabling pin connected to a respective one of the signal output pins of the counter.

In an exemplary method for driving a shift register system, the shift register system comprising a counter, a number m (m≧1) of switches, and a shift register having a number n (n≧1) of output pins, the method comprising the following steps: triggering the counter to be in an on state by an external start signal received from a first external circuit; transmitting a first start signal to activate the shift register to be in an on state by the counter; transmitting a second start signal to activate a switch j (1≦j≦m) to be in an on state by the counter; transmitting a plurality of shift signals from the output pins of the shift register to the switch j when the switch j is in the on state; providing the plurality of shift signals to a second external circuit when the switch j is in the on state; transmitting a third start signal to activate a switch j+1 to be in an on state by the counter; transmitting a plurality of shift signals from the output pins of the shift register to the switch j+1 when the switch j+1 is in the on state; and providing the plurality of shift signals to the second external circuit when the switch j+1 is in the on state.

An exemplary circuit for driving a liquid crystal display includes a plurality of gate lines that are parallel to each other and that each extend along a first direction, a plurality of data lines that are parallel to each other and that each extend along a second direction orthogonal to the first direction, a plurality of thin film transistors provided in the vicinity of respective points of intersection of the gate lines and the data lines, a data driving circuit connected to the plurality of data lines, and a gate driving circuit connected to the plurality of gate lines. The gate driving circuit includes a shift register system. The shift register system system includes a counter, a shift register and a plurality of switches. The counter includes a signal receiving pin which is for connection to a first external circuit, a pulse output pin, and a number of signal output pins. The shift register includes sixty-four register units therein, sixty-four output pins, a start pin connected to the pulse output pin of the counter, a controlling pin connected to the signal receiving pin of the counter. Each switch includes sixty-four input pins connected to the output pins of the shift register through a bus line, sixty-four output pins that are for connection to a second external circuit, and an enabling pin connected to a respective one of the signal output pins of the counter.

Other advantages and novel features will become more apparent from the following detailed description when taken in conjunction with the accompanying drawings, in which:

### BRIEF DESCRIPTION OF THE DRAWINGS

FIG. 1 is an abbreviated circuit diagram of a shift register system in accordance with an exemplary embodiment of the present invention;

FIG. 2 is an abbreviated timing chart of signals transmitted in the shift register system of FIG. 1;

FIG. 3 is essentially an abbreviated circuit diagram of an exemplary liquid crystal display using the shift register system of FIG. 1; and

FIG. 4 is essentially an abbreviated circuit diagram of a conventional active matrix LCD.

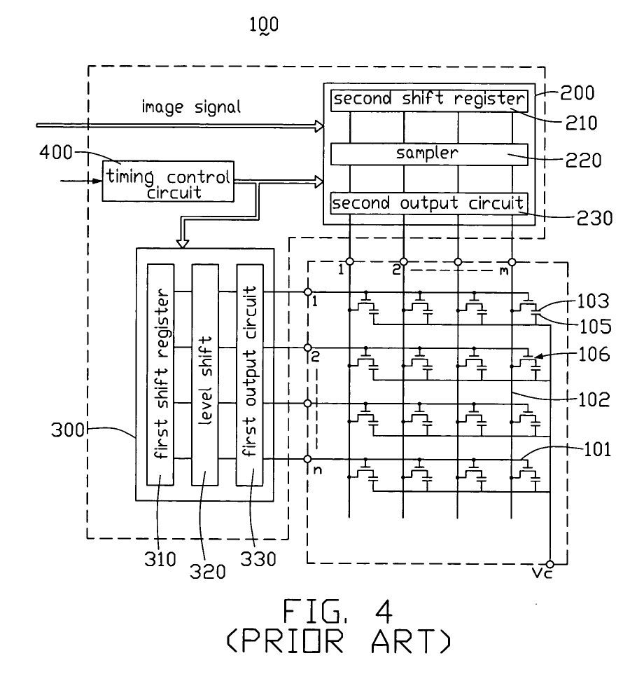

### DETAILED DESCRIPTION OF EMBODIMENTS

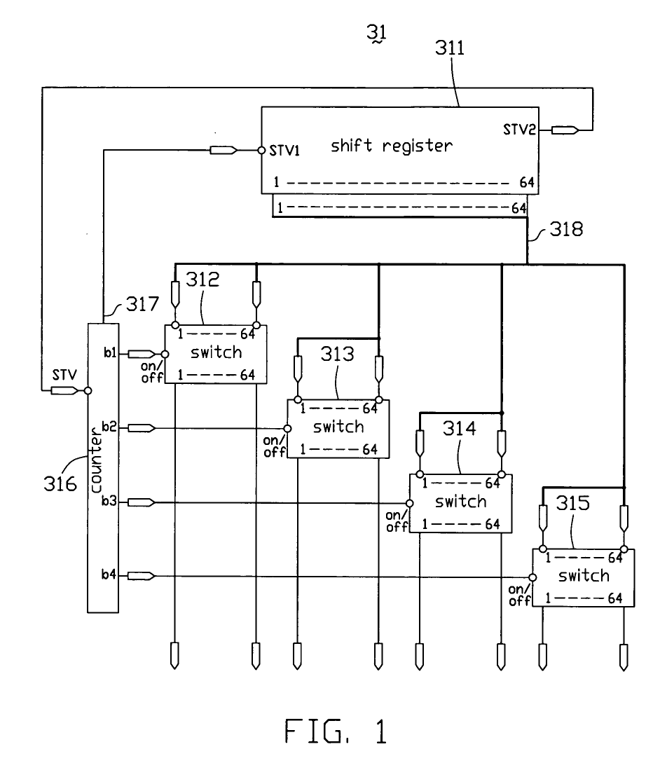

FIG. 1 is an abbreviated circuit diagram of a shift register system in accordance with an exemplary embodiment of the present invention. The shift register system 31 includes a counter 316, a shift register 311, a first switch 312, a second switch 313, a third switch 314, and a fourth switch 315.

The counter 316 includes a signal receiving pin STV which is connected to a first external circuit (not shown), a pulse output pin 317, and four signal output pins b1, b2, b3, b4.

The shift register 311 includes sixty-four register units (not shown) integrated therein, sixty-four output pins, a start pin STV1 which is connected to the pulse output pin 317 of the counter 316, a controlling pin STV2 connected to the signal receiving pin STV of the counter 316.

Each of the switches 312, 313, 314, 315 includes sixty-four input pins that are connected to the output pins of the shift register 311 through a bus line 318, sixty-four output pins that are connected to a second external circuit (not shown), and an enabling pin on/off which is connected to a respective one of the signal output pins (b1, b2, b3, b4) of the counter 316.

In particular, the enabling pin on/off of the first switch 312 is connected to the signal output pin b1 of the counter 316. The enabling pin on/off of the second switch 313 is connected to the signal output pin b2 of the counter 316. The enabling pin on/off of the third switch 314 is connected to the signal output pin b3 of the counter 316. The enabling pin on/off of the fourth switch 315 is connected to the signal output pin b4 of the counter 316. Accordingly, the shift register system 31 has two hundred and fifty-six output pins. The shift register system 31 may have an expanded number of output pins according to a desired quantity of switches used therein.

A method for driving the shift register system 31 includes the following steps: triggering the counter 316 to be in an on state by an external start signal received from the first external circuit; transmitting a first start signal to activate the shift register 311 to be in an on state by the counter 316; transmitting a second start signal to activate a switch j (312≦j≦315) to be in an on state by the counter 316; transmitting a plurality of shift signals from the output pins of the shift register 311 to the switch j when the switch j is in the on state; providing the plurality of shift signals to the second external circuit when the switch j is in the on state; transmitting a third start signal to activate a switch j+1 to be in an on state by the counter 316; transmitting a plurality of shift signals from the output pins of the shift register 311 to the switch j+1 when the switch j+1 is in the on state; and providing the plurality of shift signals to the second external circuit when the switch j+1 is in the on state.

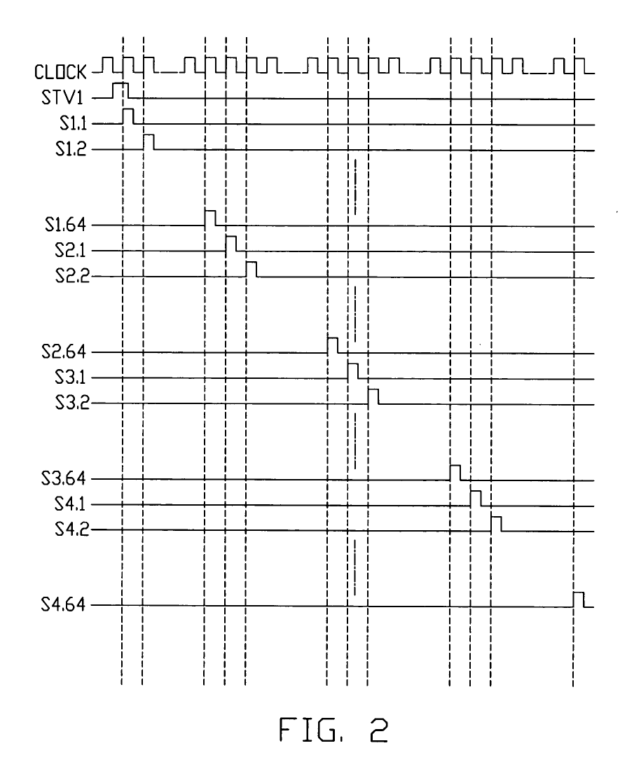

FIG. 2 is an abbreviated timing chart of signals transmitted in the shift register system 31. In operation, the signal receiving pin STV of the counter 316 receives a start pulse signal from the first external circuit to be in an on state. Then, the counter 316 provides a first start signal to the start pin STV1 of the shift register 311 and synchronously provides a second start signal to the enabling pin on/off of the first switch 312 to activate it. When the shift register 311 receives the first start signal, it generates a plurality of shift signals and provides the shift signals to the sixty-four output pins thereof. Because the first switch 312 is already turned on by reason of the enabling pin on/off thereof receiving the second start pulse signal, the first switch 312 receives the shift signals provided by the shift register 311 and outputs the shift signals from the sixty-four output pins thereof. The shift signals outputted by the first switch 312 are shown as S1.1-S1.64 in FIG. 2. At the same time, the other switches 313, 314, 315 are in an off state.

After sixty-three clock periods, the controlling pin STV2 of the register 311 applies a first feeding signal to the signal receiving pin STV of the counter 316. Then, the counter 316 provides a third start signal to the enabling pin on/off of the second switch 313 to activate it. Because the second switch 313 is turned on by reason of the enabling pin on/off thereof receiving the third start signal, the second switch 313 receives the shift signals provided by the shift register 311 and outputs the shift signals from the sixty-four output pins thereof. The shift signals outputted by the second switch 313 are shown as S2.1-S2.64 in FIG. 2. At the same time, the other switches 312, 314, 315 are in an off state.

After sixty-three clock periods, the controlling pin STV2 of the register 311 applies a second feeding signal to the signal receiving pin STV of the counter 316. Then, the counter 316 provides a fourth start signal to the enabling pin on/off of the third switch 314 to activate it. Because the third switch 314 is turned on by reason of the enabling pin on/off thereof receiving the fourth start signal, the third switch 314 receives the shift signals provided by the shift register 311 and outputs the shift signals from the sixty-four output pins thereof. The shift signals outputted by the third switch 314 are shown as S3.1-S3.64 in FIG. 2. At the same time, the other switches 312, 313, 315 are in an off state.

After sixty-three clock periods, the controlling pin STV2 of the register 311 applies a third feeding signal to the signal receiving pin STV of the counter 316. Then, the counter 316 provides a fifth start signal to the enabling pin on/off of the fourth switch 315 to activate it. Because the fourth switch 315 is turned on by reason of the enabling pin on/off thereof receivign the fifth start signal, the fourth switch 315 receives the shift signals provided by the shift register 311 and outputs the shift signals from the sixty-four output pins thereof. The shift signals outputted by the fourth switch 315 are shown as S4.1-S4.64 in FIG. 2. At the same time, the other switches 312, 313, 314 are in an off state.

After sixty-three clock periods, the controlling pin STV2 of the register 311 applies a fourth feeding signal to the signal receiving pin STV of the counter 316. Then the counter 316 either applies a second start signal to the enabling pin on/off of the first switch 312 to activate it, or stops working.

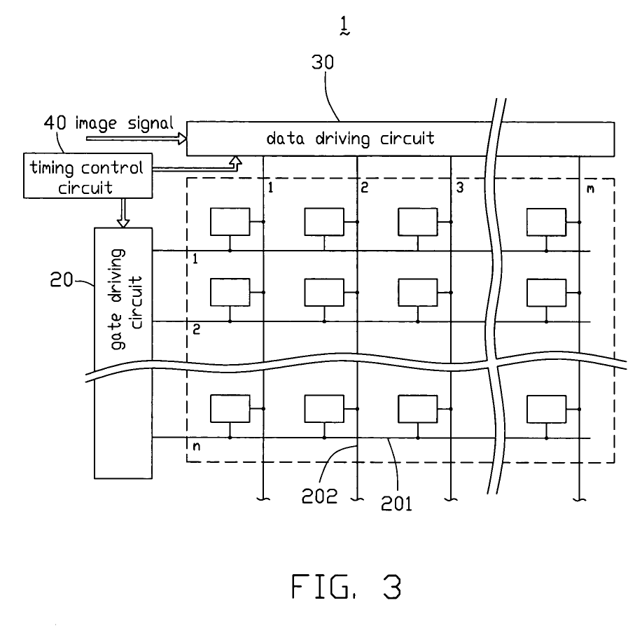

FIG. 3 is essentially an abbreviated circuit diagram of an exemplary liquid crystal display using the shift register system 31. The liquid crystal display 1 includes a first substrate (not shown), a second substrate (not shown), a liquid crystal layer (not shown) sandwiched between the first and second substrates, a gate driving circuit 20, a data driving circuit 30, and a timing control circuit 40. The first substrate includes a number n (where n is a natural number) of gate lines 201 that are parallel to each other and that each extend along a first direction, and a number m (where m is also a natural number) of data lines 202 that are parallel to each other and that each extend along a second direction orthogonal to the first direction. The first substrate also includes a plurality of thin film transistors (not shown) that function as switching elements. Each TF1 is provided in the vicinity of a respective point of intersection of the gate lines 201 and the data lines 202.

The gate driving circuit 20 includes a shift register (not shown), a level shift (not shown) for transforming the scanning signals to a plurality of voltages, and an output circuit (not shown) connected to the plurality of gate lines. The level shift has a same configuration as that of the shift register 311.

The data driving circuit 30 mainly includes a shift register (not shown) for receiving image signals, a sampler (not shown) for transforming the image signals to a plurality of voltages, and an output circuit (not shown) connected to the plurality of data lines 202.

The above-described exemplary shift register system 31 has two hundred and fifty-six output pins. Unlike in the conventional shift register used in the above-described conventional gate driving circuit 300, the shift register system 31 may have a reduced or expanded number of output pins according to a selected quantity of switches used therein.

It is to be understood, however, that even though numerous characteristics and advantages of the exemplary embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A shift register system comprising:
a counter comprising a signal receiving pin which is for connection to a first external circuit, a pulse output pin, and a number of signal output pins;
a shift register comprising sixty-four register units therein, sixty-four output pins, a start pin connected to the pulse output pin of the counter, and a controlling pin connected to the signal receiving pin of the counter; and
a plurality of switches, each of the switches comprising sixty-four input pins that are connected to the output pins of the shift register through a bus line, sixty-four output pins which are for connection to a second external circuit, and an enabling pin connected to a respective one of the signal output pins of the counter.

2. The shift register system as claimed in claim 1, wherein the number of switches is four.

3. A method for driving a shift register system, the shift register system comprising a counter, a number m (m≧1) of switches, and a shift register having a number n (n≧1) of output pins, the method comprising the following steps:
triggering the counter to be in an on state by an external start signal received from a first external circuit;
transmitting a first start signal to activate the shift register to be in an on state by the counter;
transmitting a second start signal to activate a switch j (1≦j≦m) to be in an on state by the counter;
transmitting a plurality of shift signals from the output pins of the shift register to the switch j when the switch j is in the on state;
providing the plurality of shift signals to a second external circuit when the switch j is in the on state;
transmitting a third start signal to activate a switch j+1 to be in an on state by the counter;
transmitting a plurality of shift signals from the output pins of the shift register to the switch j+1 when the switch j+1 is in the on state; and
providing the plurality of shift signals to the second external circuit when the switch j+1 is in the on state.

4. The method as claimed in claim 3, wherein m is equal to four.

5. The method as claimed in claim 4, wherein n is equal to sixty-four.

6. A circuit for driving a liquid crystal display, comprising:
a plurality of gate lines that are parallel to each other and that each extend along a first direction;
a plurality of data lines that are parallel to each other and that each extend along a second direction orthogonal to the first direction;
a plurality of thin film transistors provided in the vicinity of respective points of intersection of the gate lines and the data lines;
a data driving circuit connected to the plurality of data lines; and
a gate driving circuit connected to the plurality of gate lines, the gate driving circuit comprising a shift register system, the shift register system comprising:
a counter comprising a signal receiving pin which is for connection to a first external circuit, a pulse output pin, and a number of signal output pins;
a shift register comprising sixty-four register units therein, sixty-four output pins, a start pin connected to the pulse output pin of the counter, and a controlling pin connected to the signal receiving pin of the counter, and
a plurality of switches, each of the switches comprising sixty-four input pins that are connected to the output pins of the shift register through a bus line, sixty-four output pins that are for connection to a second external circuit, and an enabling pin connected to a respective one of the signal output pins of the counter.

7. The circuit as claimed in claim 6, wherein the number of switches is four.
